(19) United States
(12) Patent Application Publication
(10) Pub. No.: US 2015/0061383 A1
(43) Pub. Date: Mar. 5, 2015

(54) Start Control System for Hybrid Driving Mechanism

(71) Applicant: NABTESCO CORPORATION, Tokyo (JP)

(72) Inventor: Yasunaga Kobayashi, Kobe-shi (JP)

(21) Appl. No.: 14/381,631

(22) PCT Filed: Feb. 21, 2013
(86) PCT No.: PCT/JP2013/054300

§ 371 Date: Aug. 28, 2014

(30) Foreign Application Priority Data
Feb. 28, 2012 (JP) 2012-041412

(51) Int. Cl. B60L 11/02; B60L 11/18

(52) U.S. Cl. CPC B60L 11/02; B60L 11/1803; Y10S 903/907
USPC 307/10.1; 180/65.28; 903/907

(57) ABSTRACT

A motor-generator (2) coupled to an engine (4) generates power and has a starter function for the engine (4). A pump (6) is driven by the power of the engine (4). A generator-motor (14) is driven by power generated by the motor-generator (2) through an indirect matrix converter (8). The power generated by the generator is stored in a capacitor (22) through a converter (10) and a chopper (20) of the indirect matrix converter (8). A battery (26) is coupled through a chopper (24) to a capacitor (22).

### TECHNICAL FIELD

The present invention relates to a start control system for controlling starting of an engine that a hybrid driving mechanism has.

### BACKGROUND ART

A machine with a hybrid driving mechanism has a generator in addition to an engine. The generator drives a motor, which, in turn, drives parts to be driven. In order to operate the engine, a starter is used, but the use of starter causes increase of costs of machines with a hybrid driving mechanism. Patent Literature 1 discloses a technique to start an engine without resort to a starter. According to the technique of Patent Literature, when a request to start an engine is made while a vehicle is being driven only by a motor, driving force from driving wheels of the vehicle is transmitted to the engine by means of a driving force dividing function to thereby start the engine.

### PRIOR TECHNIQUE LITERATURES

### Patent Literature

Patent Literature 1: JP2007-55291A

### SUMMARY OF INVENTION

### Technical Problem

According to the technology disclosed in Patent Literature 1, in order to start the engine, it is necessary for the motor to be rotating. Accordingly, when the motor is not rotating when, for example, it is required to start the entire hybrid driving mechanism, the technology of Patent Literature 1 cannot be used. It may be possible to provide the hybrid driving mechanism with a charge-discharge device, e.g. a battery, and the power provided by the charge-discharge device is supplied to the motor to thereby start the engine by the rotation of the motor. However, if the charge-discharge device has been discharged out when the hybrid driving mechanism as a whole is to be started, the motor cannot rotate and, therefore, the engine cannot be started.

An object of the present invention is to provide a hybrid driving mechanism start control system which can start an engine even when a charge-discharge device has been discharged.

### Solution to Problem

A hybrid driving mechanism start control system according to an embodiment of the present invention includes a generator. The generator is coupled to an engine and generates electricity. Also, the generator has a starter function to start the engine. For example, the generator may be one which can be used also as a motor. Further, the generator may be an AC generator. A unit to be driven is driven by the output of the engine. There may be a variety of driven units. In case of hybrid construction machines, the driven unit may be a hydraulic pump which serves as a driving source for a crawler vehicle. In case of hybrid vehicles, driving wheels may be a driven unit. A motor is driven by electric power generated by the generator. As the motor, one which can be used also as a generator may be used. The motor may be an AC motor. In case of hybrid construction machines, the motor may be used to turn, stretch or retract a boom. When the machine is a hybrid vehicle, the motor may be used to drive driving wheels. The electric power generated by the generator is stored in a capacitor. The capacitor is chargeable. A transformer is disposed between the capacitor and the generator. The transformer is used to store the power the generator generates in the capacitor, and may be, for example, one to transform AC power to DC power. Also, the transformer may be used to provide power from the capacitor to the generator to operate the generator as a motor. The transformer may be used with another transformer which is used to supply driving power to the motor. The transformer may form, together with the said another transformer, motor driving means, e.g. a matrix converter. Alternatively, the motor driving means may be, for example, a combination of AC-to-DC converting means and DC-to-AC converting means. Lower-voltage storage means connectable to the capacitor is provided. A battery, for example, may be used as the lower-voltage storage means. The rated voltage of the lower-voltage storage means is lower than the rated voltage of the capacitor. A voltage-booster is disposed between the lower-voltage storage means and the capacitor. Preferably, the voltage-booster can charge the lower-voltage storage means through the transformer and boost the voltage of the lower-voltage storage means for supplying power to the generator through the transformer.

If the motor has not been activated and the capacitor has been discharged when the engine is going to be started by means of the hybrid driving mechanism start control system having the above-described arrangement, the voltage of the lower-voltage storage means is boosted by the voltage booster and the boosted voltage is supplied to the motor to thereby rotate the motor. The rotation of the motor causes the engine to start operating.

### BRIEF DESCRIPTION OF DRAWING

FIG. 1 is a block diagram of a hybrid driving mechanism start control system according to an embodiment of the present invention.

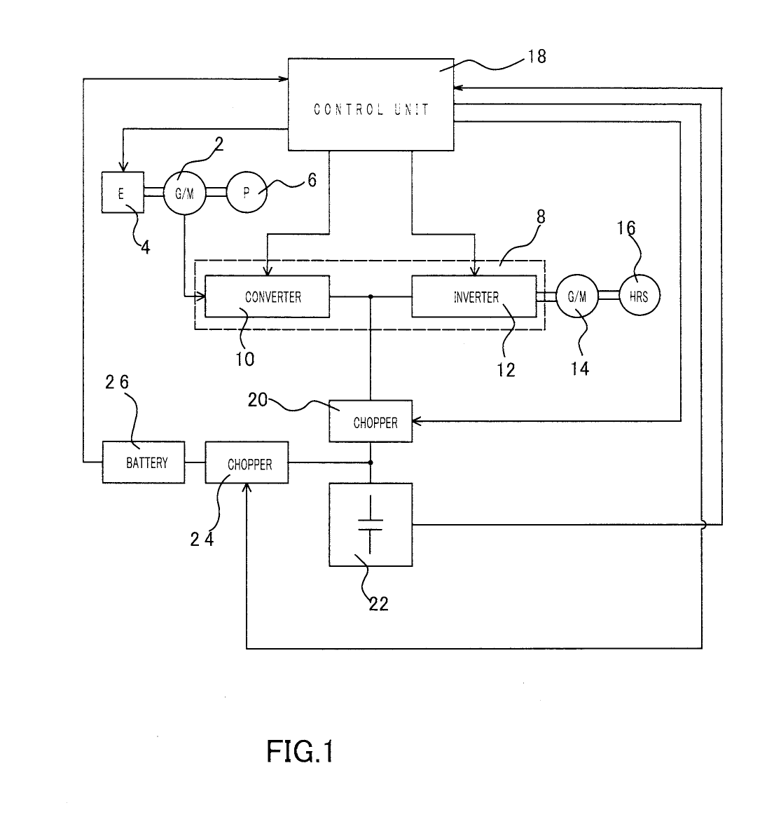

### DESCRIPTION OF EMBODIMENTS

A hybrid driving mechanism start control system according to one embodiment of the present invention is practiced in a hybrid construction machine. The hybrid construction machine includes a generator, e.g. a motor-generator 2. When an engine 4 is operating, the motor-generator 2 is driven as a generator by the engine 4. The motor-generator 2 is coupled to the engine 4. The engine 4 is coupled also to a driven unit, e.g. a pump 6. When the engine 4 is operating, the motor-generator 2 generates electricity and, at the same time, the pump is driven. The pump 6 serves as a driving source for hydraulic actuators of, for example, an arm cylinder, a boom cylinder, a bucket cylinder, and hydraulic travel motors. The motor-generator 2 is operable as a motor, and, when it is operating as a motor with the engine 4 not operating, the motor-generator 2 can be used to start up the engine 4.

The motor-generator 2 is driven by the engine 4 to thereby generate AC power. The AC power is transformed into AC power having a desired frequency and a desired voltage value by motor driving means, e.g. a converter, e.g.

a converter 10 of an indirect matrix converter 8, and an inverter 12 of the indirect matrix converter 8, and, then, supplied to a motor, e.g. a generator-motor 14. The generator-motor 14 rotates from the AC power supplied from the indirect matrix converter 8. In the hybrid construction machine, the generator-motor 14 is coupled to a top rotating carriage of the hybrid construction machine via a rotating system (HRS) 16 in order to rotate the top rotating carriage.

The converter 10 and the inverter 12 are controlled by control means, e.g. a control unit 18. The control unit 18 controls the engine 4, too.

The converter 10 and the inverter 12 of the indirect matrix converter 8 each have a plurality of semiconductor switching devices, e.g. IGBTs or FETs. The IGBTs or FETs are ON-OFF controlled by the control unit 18. The converter 10 converts the supplied AC voltage to an intermediate DC voltage, and the inverter 12 converts the intermediate DC voltage to an AC voltage having a desired frequency and a desired voltage value. The resulting AC voltage is supplied to the generator-motor 14.

When the motor-generator 2 is rotating as a generator, the intermediate DC voltage, which is the output of the converter 10 of the indirect matrix converter 8, is supplied to a capacitor 22, e.g. an EDLC (electric double layer capacitor), through a converter, e.g. a chopper 20, to thereby charge the capacitor 22. The chopper 20 is controlled by the control unit 18 so as to make the charging performed. The chopper 20 includes at least one semiconductor switching device, e.g. an IGBT or an FET, which is ON-OFF controlled by the control unit 18.

The charge voltage on the capacitor 22 is supplied to the control unit 18. When the charge voltage is lower than a predetermined charging START voltage predetermined for the capacitor 22, which means the capacitor 22 has been considerably discharged, the chopper 20 is controlled by the control unit 18 to charge the capacitor 22. When the voltage of the capacitor 22 becomes higher than a capacitor charging STOP voltage predetermined for the capacitor 22, which means that the charge voltage indicates that the capacitor 22 has been sufficiently charged, the chopper 20 is so controlled by the control unit 18 to charge the capacitor 22 no more. The capacitor charging STOP voltage may be equal to the capacitor charging START voltage or may be higher than the capacitor charging START voltage. The regenerated power from the generator-motor 14 is also used to charge the capacitor 22 via the inverter 12 and the chopper 20. For a hybrid construction machine, relative large regenerated power is generated in the generator-motor 14 in a short time, the capacitor 22 is desirably an EDLC having a short charging time.

The power charged in the capacitor 22 may be used, through the chopper 20 and the converter 10, to drive the motor-generator 2 as a motor. The chopper 20 and the converter 10 serve as bidirectional power passing means or charge-discharge means which can not only charge the capacitor 22 with power generated by the motor-generator 2 but also cause power in the capacitor 22 to be discharged to the motor-generator 2. The converter 10 and the chopper 20 are controlled by the control unit 18, and selected ones of the IGBTs or FETs of the converter 10 and the chopper 20 are placed in the ON state, whereby the power in the capacitor 22 can be supplied to the motor-generator 2.

Let it be assumed that both the engine 4 and the motor-generator 2 of the hybrid construction machine are not operating. In order to start up the engine 4, the power stored in the capacitor 22 is supplied to the motor-generator 2 through the chopper 20 and the converter 10 to thereby rotate the motor-generator 2 as a motor, and, then, the engine 4 is actuated by the rotation of the motor-generator 2. In other words, the motor-generator 2 operates also as a starter for the engine 4.

Lower-voltage storage means, e.g. a battery 26, is connected to the junction of the chopper 20 and the capacitor 22 through a voltage-booster, e.g. a chopper 24. The chopper 24, too, includes at least one semiconductor switching device, e.g. an IGBT or FET, and also a voltage-boosting inductor or a voltage-transformer. The chopper 24 is ON-OFF controlled by the control unit 18.

The battery 26 has a rated voltage lower than that of the capacitor 22, and is charged, when the motor-generator 2 is operating as a generator, by the power from the motor-generator 2 through the choppers 20 and 24 and the converter 10, or charged by the regenerated power from the motor-generator 14 through the inverter 12 and the choppers 20 and 24. The chopper 24, too, is controlled by the control unit 18. For example, the charged voltage on the battery 26 is supplied to the control unit 18. The converter 10 or the inverter 12 and the choppers 20 and 24 are controlled in such a manner that the battery 26 is charged when the voltage coupled to the control unit 18 is lower than a battery charging START voltage predetermined for the battery 26, and that the charging of the battery 26 is stopped when the voltage coupled to the control unit 18 is higher than a battery charging STOP voltage predetermined for the battery 26. The battery charging START voltage is set to a voltage lower than the capacitor charging START voltage for the capacitor 22. The battery charging STOP voltage may be equal to the battery charging START voltage, or it may be higher than the battery charging START voltage. It should be noted that the battery charging STOP voltage is set to be lower than the capacitor charging START voltage and the capacitor charging STOP voltage.

The chopper 24 may boost the voltage of the battery 26 to a voltage equal to the voltage of the capacitor 22 before applying it to the motor-generator 2 through the chopper 20 and the converter 10.

There may be a case where, when it is required for the engine 4 to be actuated while neither the engine 4 nor the motor-generator 2 of this hybrid construction machine is operating, the capacitor 22 has been discharged. There may be a case where, when an EDLC is used as the capacitor 22, the capacitor 22 has discharged to such an extent that the engine 4 cannot be ignited when an operator tries to start the hybrid construction machine in the morning after it is stopped and left in a construction site in the evening of a previous day, i.e. only one night later. In such cases, the capacitor 22 cannot supply power to the motor-generator 2 through the chopper 20 and the converter 10. To overcome the problem, the control unit 18 controls the chopper 24 to boost the voltage of the battery 26 up to the voltage of the capacitor 22, and the boosted voltage is applied to the motor-generator 2 through the chopper 20 and the converter 10. This makes the motor-generator 2 operate as a motor, causing the engine 4 to rotate. Once the engine 4 is actuated, the motor-generator 2 can be operated as a generator, and the capacitor 22 can be charged, and, furthermore, the generator-motor 14 can be operated as a motor through the indirect matrix converter 8. Since it is sufficient that the battery 26 can drive the motor-generator 2 as the starter for the engine 4, the battery 26 can be of a small capacity, so that the charging of the battery 26 does not impede the charging of the capacitor 22.

In the described embodiment, the generator-motor 14 is used to rotate a top rotating carriage, but the invention is not limited to it. The generator-motor 14 may be arranged to drive the hydraulic pump 6. Further, in the described embodiment, the battery 26 is used as lower-voltage storage means, but a capacitor may be used instead. Although the converter 20 of the indirect matrix converter 8 is used as a converter in the described embodiment, the invention is not limited to it, and an AC-to-DC converter to convert the AC voltage provided by the motor-generator 2 into a DC voltage may be used instead. In this case, in order to drive the generator-motor 14, a DC-to-AC converter for converting the DC voltage from the AC-to-DC converter to an AC voltage is used.

1. A hybrid driving mechanism start control system, comprising:
an engine;
a generator coupled to said engine, said generator generating electric power and having a starter function for activating said engine;
a driven unit adapted to be driven by an output of said engine;
a capacitor in which power generated by said generator is stored; and
a converter disposed between said capacitor and said generator;
wherein there is further provided lower-voltage storage means connectable to said capacitor; and
a voltage booster disposed between said lower-voltage storage means and said capacitor.

2. The hybrid driving mechanism start control system according to claim 1, wherein said converter can couple power from said generator to said capacitor and also can couple, from said capacitor, power for operating said generator as a motor to said generator.

3. The hybrid driving mechanism start control system according to claim 2, wherein the power in said lower-voltage storage means of which voltage has been boosted by said voltage booster is coupled to said generator through said converter as power for operating said generator as a motor.
